(19) United States
(12) Patent Application Publication
(10) Pub. No.: US 2014/0041753 A1
(43) Pub. Date: Feb. 13, 2014

(54) A FLUID REFILL SYSTEM

(71) Applicants: Stéphane Beranger, Surtauville (FR); Patrick Muller, Saint Aubin sur Gaillon (FR)

(72) Inventors: Stéphane Beranger, Surtauville (FR); Patrick Muller, Saint Aubin sur Gaillon (FR)

(73) Assignee: APTAR FRANCE SAS, Le Neubourg (FR)

(21) Appl. No.: 14/111,454

(22) PCT Filed: Apr. 12, 2012
(86) PCT No.: PCT/FR2012/050792

§ 371 Date: Oct. 11, 2013

(30) Foreign Application Priority Data
Apr. 14, 2011 (FR) 1153252

(51) Int. Cl. B67D 7/02

(52) U.S. Cl. CPC B67D 7/0294
USPC 141/18

(57) ABSTRACT

A fluid refill system includiung a source bottle; a refillable travel bottle including a dispenser pump, the travel bottle presenting a capacity that is smaller than the capacity of the source bottle; and connection for connecting the two bottles together so as to fill the travel bottle with fluid from the source bottle, the connection including a fluid inlet and an air outlet for the source bottle, and a fluid outlet and an air inlet for the travel bottle, the connection defining an internal fluid passage connecting the fluid inlet to the fluid outlet, and an internal air passage connecting the air inlet to the air outlet. The internal fluid passage and the internal air passage are arranged coaxially, the air passage surrounding the fluid passage or vice versa.

The present invention relates to a fluid refill system comprising a source bottle, a refillable travel bottle provided with a dispenser pump, and connection means for connecting the two bottles together. The connection means include a fluid outlet and an air inlet at the travel bottle, and a fluid inlet and an air outlet at the source bottle. The connection means define an internal fluid passage connecting the fluid inlet to the fluid outlet, and an internal air passage connecting the air inlet to the air outlet. The advantageous field of application of the present invention is the field of perfumery in which the use of travel bottles is more and more widespread. In its broadest sense, the term “travel bottle” means any dispenser of small size that is refillable from a source bottle of larger size. However, the invention may also apply to the fields of cosmetics and pharmacy.

In the prior art, document WO 2010/092310 is known that describes a dispenser device comprising a source first bottle and a travel second bottle that are suitable for being connected together in such a manner as to enable fluid to be transferred from the source bottle to the travel bottle, and air to be transferred from the travel bottle to the source bottle. To do this, the document describes appropriate connection means for performing such cross transfers of fluid and of air. In a particular embodiment of that document, the connection means comprise two connectors, one for the fluid and the other for the air, arranged one next to the other, in parallel. As a result, the operation of connecting the two bottles together is not easy, since it requires two connections to be made simultaneously, given that the connectors are arranged in parallel. Furthermore, it turns out that the cross flows of fluid and of air are difficult to initiate, and this is undoubtedly because of capillarity phenomena associated with the small flow sections of the connectors.

An object of the present invention is to remedy the above-mentioned drawbacks of the prior art by defining a refill system, for refilling a travel bottle from a source bottle, having connection means that define internal fluid and/or air passages that do not present any difficulty while the bottles are being connected together. Furthermore, the internal passage should enable the fluid and/or the air to flow easily therethrough.

To do this, the present invention proposes a fluid refill system comprising: a source bottle; a refillable travel bottle including a dispenser pump, the travel bottle presenting a capacity that is smaller than the capacity of the source bottle; and connection means for connecting the two bottles together so as to fill the travel bottle with fluid from the source bottle, the connection means including a fluid inlet and an air outlet for the source bottle, and a fluid outlet and an air inlet for the travel bottle, the connection means defining an internal fluid passage connecting the fluid inlet to the fluid outlet, and an internal air passage connecting the air inlet to the air outlet; the fluid refill system being characterized in that the internal fluid passage and the internal air passage are arranged coaxially, the air passage surrounding the fluid passage or vice versa. The coaxial arrangement of the internal fluid and air passages makes it possible to have single connection means, which makes the connection operation considerably easier for the user. Although in the prior art the user must take care to connect the two connectors simultaneously in parallel, in the present invention the user is aware of making only a single connection, with two connections being made simultaneously and automatically without the user even realizing that the single connector includes an air passage. In other words, the air passage becomes invisible to the user, and constitutes nothing more than an accessory of the fluid passage that is essential for refilling the travel bottle. The fact that the air connection is hidden results directly from the coaxial arrangement of the internal fluid and air passages.

According to an advantageous characteristic of the invention, the connection means may comprise two connectors that are suitable for being connected together, namely a source connector forming the fluid inlet and the air outlet, and a travel connector forming the fluid outlet and the air inlet. Advantageously, the connectors include coaxial connection means for connecting the internal passages in coaxial manner. The fluid outlet and the air inlet do not need to be coaxial. Likewise, the fluid inlet and the air outlet do not need to be coaxial. In contrast, it is advantageous for the connection means, that make it possible to connect the two connectors together, to define internal passages that are coaxial, so as to make the connection operation easier for the user.

According to another advantageous characteristic of the invention, the connection means may include thrust means for initiating the movement of the fluid and/or of the air in a determined direction. Advantageously, the thrust means comprise at least one thrust piston for thrusting the air towards the air outlet and/or the fluid towards the fluid outlet. Preferably, the thrust piston is biased by a return spring, the piston being moved against the action of the return spring while the two connectors are being connected together. It should be observed that such a thrust piston for thrusting the fluid and/or the air may be used in any type of connection means, and not necessarily in connection means of coaxial type as recommended by the present invention. In other words, a thrust piston for initiating the movement of the fluid and/or of the air may be used in any connector, such as the connector described in document WO 2010/092310 for example, in which the two connectors for the fluid and the air are arranged side by side, in parallel.

In another advantageous aspect of the present invention, the refill system may include two thrust pistons for thrusting the air and the fluid, the pistons being arranged in coaxial manner. Advantageously, both thrust pistons are annular. It is thus possible to use two thrust pistons in a single coaxial connector. According to another characteristic of the invention, each piston moves between a rest position in which the internal passage(s) is closed, and a flow position in which the internal passage(s) is open. Thus, the piston also serves as an internal passage shutter, avoiding any fluid leaking. This characteristic may be used in any type of connector, and not necessarily in a coaxial connector as recommended by the present invention.

In another aspect of the invention, the source connector includes a valve for closing the internal fluid passage, the valve being pushed into its flow position against a valve spring by the travel connector while the two connectors are being connected together. The main function of the valve is to prevent any fluid from leaking from the source bottle. The valve may also be incorporated in any type of connector that uses a thrust piston, without the piston necessarily being coaxial.

According to another characteristic of the invention, the travel connector may be arranged at an end of the travel bottle, that is remote from the dispenser pump. Thus, the travel connector may be fastened on the travel bottle in the same way as the dispenser pump. It is thus possible to use a travel bottle that is completely symmetrical, including two identical opposite ends.

A first principle of the present invention is to define connection means in the form of a single coaxial connector that enables the cross transfer of fluid and of air. A second principle of the present invention resides in the use of one or two thrust pistons, making it possible to initiate the flow of fluid and/or of air through the connector, regardless of whether said connector is coaxial.

The present invention is described more fully below with reference to the accompanying drawings, which show an embodiment of the present invention by way of non-limiting example.

In the figures:

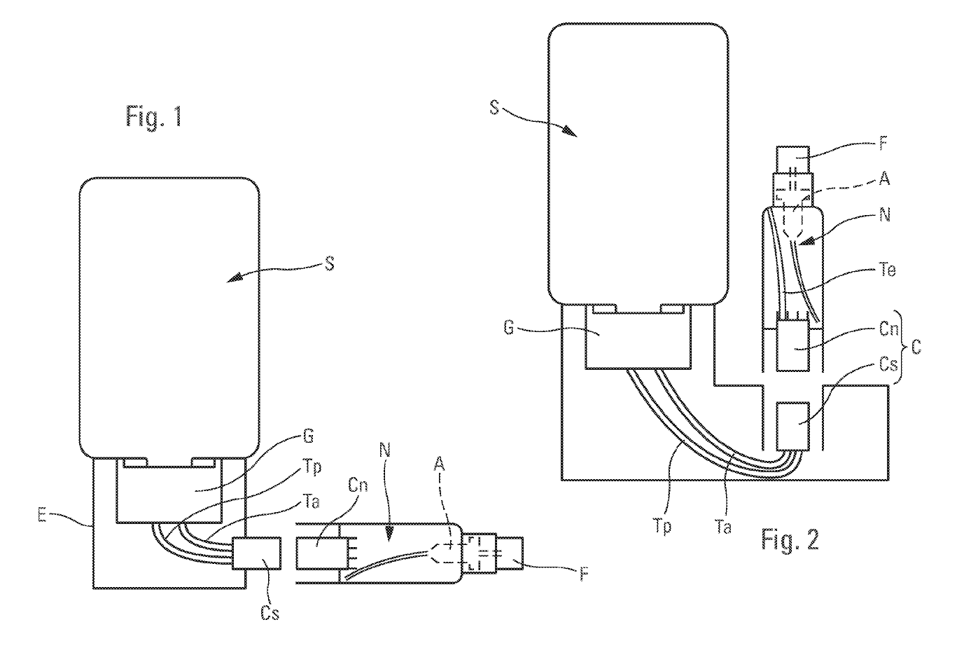

FIGS. 1 and 2 show, in very diagrammatic manner, two different configurations for refill systems of the invention, FIG. 1 showing the travel bottle on its side, while FIG. 2 shows the travel bottle upright.

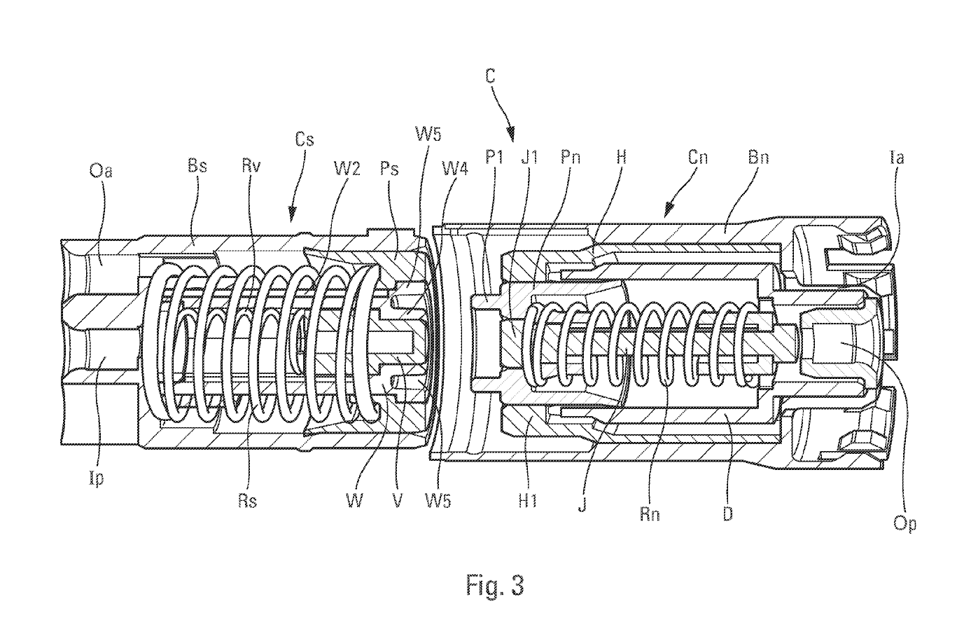

FIG. 3 is a cross-section view, partially in perspective, of connection means in an embodiment of the present invention, in their non-connected state;

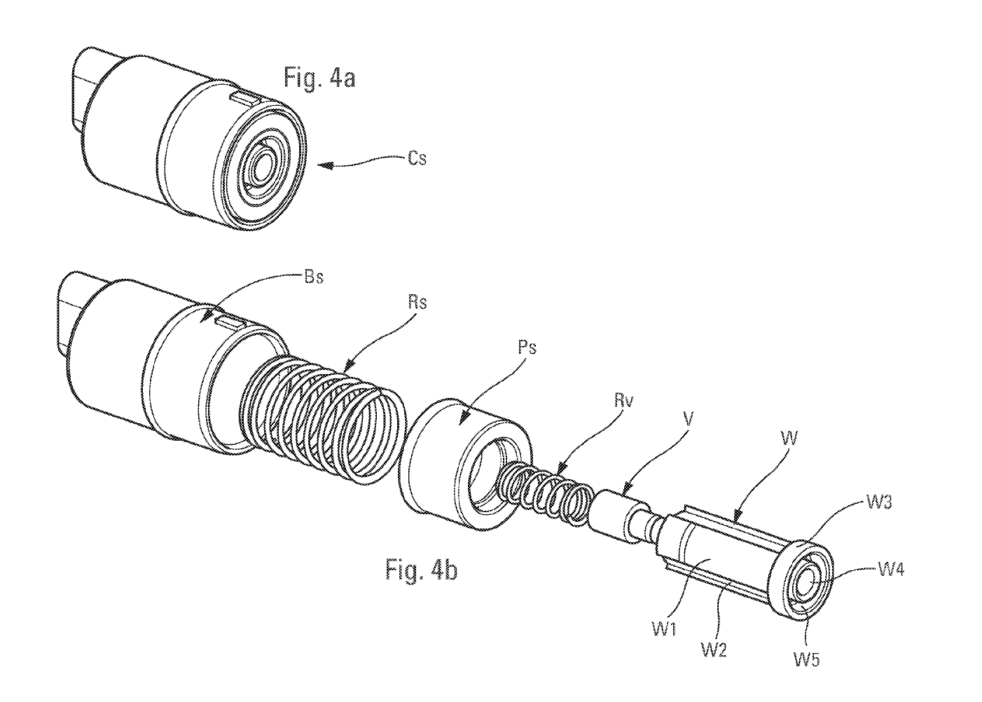

FIG. 4a is a perspective view of the source connector in its assembled state.

FIG. 4b is an exploded perspective view of the FIG. 4a source connector;

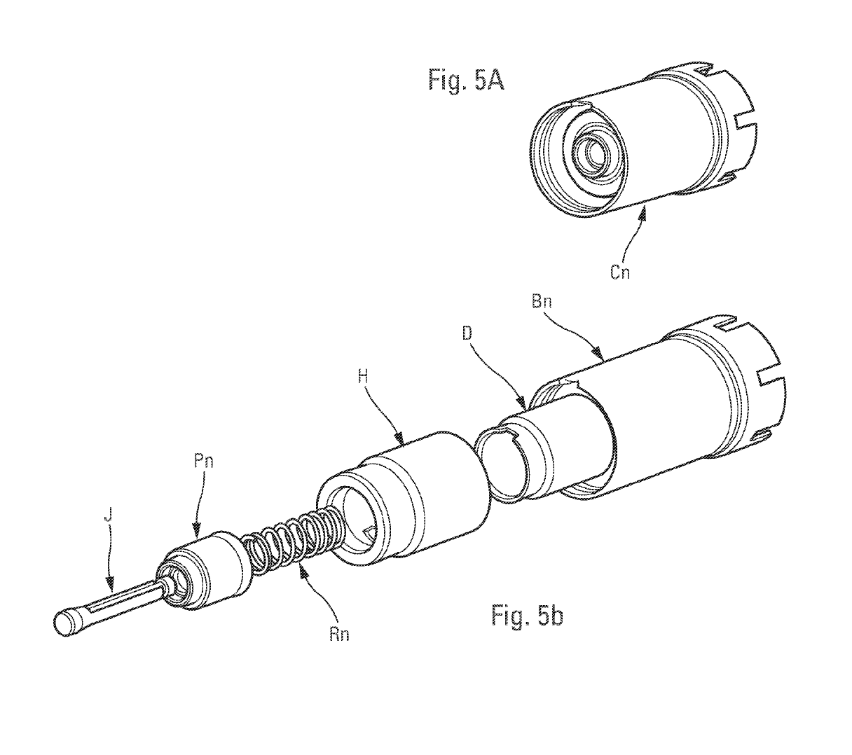

FIG. 5a is a perspective view of the travel connector in an embodiment of the present invention, in its assembled state;

FIG. 5b is an exploded perspective view of the FIG. 5a travel connector;

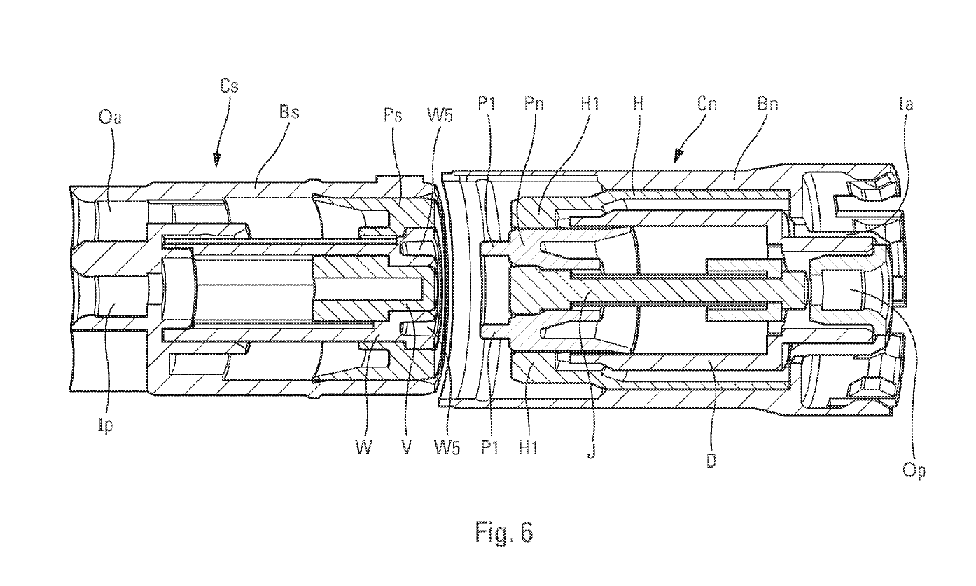

FIG. 6 is a view similar to FIG. 3 with the springs omitted so as to make it easier to understand the drawing; and

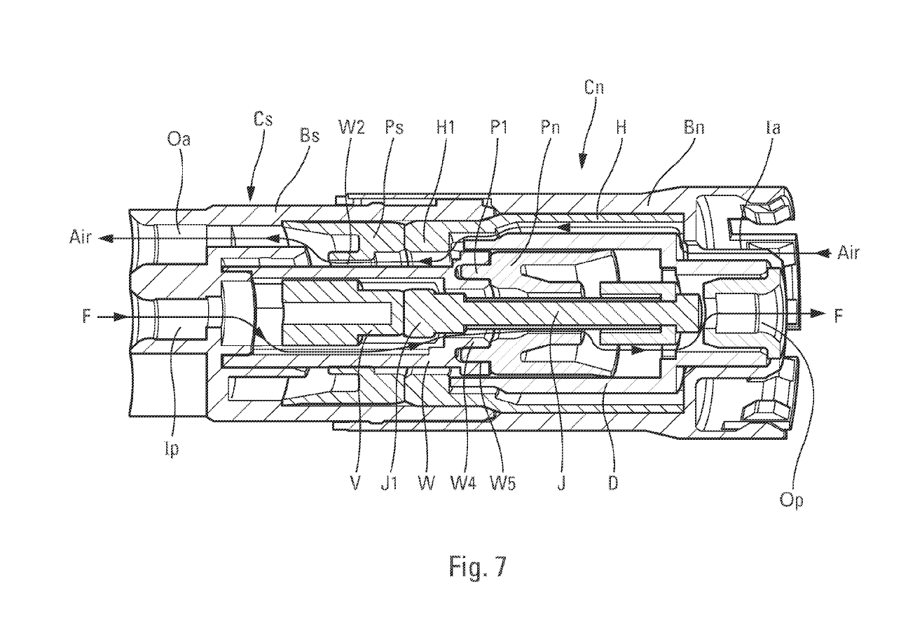

FIG. 7 is a view similar to FIG. 6 with both of the source and travel connectors connected together, and showing the fluid and air flow paths through the internal passages formed by both of the source and travel connectors.

FIGS. 1 and 2 show two different configurations for the fluid refill system of the invention. In both configurations, the system includes a source bottle S that is arranged upsidedown. The source bottle S includes a neck that is provided with a stopper G that is situated below the source bottle. The source bottle may be a refill that is replaced once empty. The source bottle S may be arranged on a base E or E′ that imparts stability to the system. The stopper G is arranged inside the base E and generally cannot be seen. Two hoses Ta and Tp communicate with the inside of the source bottle S through the stopper G, and extend inside the base E, E′ so as to be connected to a source connector Cs that is mounted on a side of the base E, E′. The hose Ta is a hose for passing air, while the hose Tp is a hose for passing fluid. In FIG. 1, the source connector Cs is arranged horizontally or on its side on a vertical wall of the base E, while in FIG. 2, the source connector Cs is arranged vertically or upright on a horizontal wall of the base E′. The difference between the two configurations in FIGS. 1 and 2 resides in the arrangement and the orientation of the source connector Cs.

The refill system of the invention also includes a travel bottle N which, at one of its ends, is provided with a pump A on which a pusher F is mounted. At its opposite end, the bottle N includes a travel connector Cn. Although not shown, the travel bottle N may comprise a reservoir body that is completely symmetrical with two identical ends on which there are mounted firstly the pump A and secondly the travel connector Cn. The reservoir body may be made of glass or of plastics material. The travel connector Cn includes a fluid outlet and an air inlet, as described below. In FIG. 2, the travel bottle N includes a vent hose Te that extends in the reservoir from the air inlet into the proximity of the pump A. Naturally, the travel bottle N presents a capacity that is smaller than the capacity of the source bottle S, since the purpose is to fill the travel bottle from the source bottle.

The source connector Cs and the travel connector Cn are designed to be connected together in such a manner as to constitute connection means C in the form of a single connector. The hose Ta is connected to the air inlet of the travel connector Cn via an internal air passage, and the fluid outlet of the connector Cn is connected to the hose Tp via an internal fluid passage. In other words, the connection means C define firstly an internal fluid passage that enables fluid to flow from the source bottle S to the travel bottle N, and secondly an internal air passage that enables air to flow from the travel bottle N to the source bottle S. The internal fluid and air passages thus make it possible to generate two cross flows of fluid and of air, making it possible to fill the travel bottle N with fluid from the source bottle S, and to evacuate air from the travel bottle N to the source bottle S. The connection means C thus make it possible to generate a cross transfer in accordance with the law of communicating vessels. In principle, the cross flows of fluid and of air are performed at atmospheric pressure. Without even going into the detail of the source and travel connectors Cs, Cn, it should already be observed that the mere connection of the two connectors makes it possible to establish the connection between the source bottle and the travel bottle, simultaneously defining an internal fluid passage and an internal air passage that enable the fluid and air to be transferred in opposite directions. This is an advantageous characteristic of the present invention.

Reference is made below to FIGS. 3 to 7 together in order to describe in detail the structure and the operation of connection means C in a particular non-limiting embodiment of the invention. The connection means C are in the form of a single connector that, as mentioned above, comprises a source connector Cs and a travel connector Cn for connecting together, so as to establish the internal fluid and air passages. The source connector Cs, that is situated on the left in FIG. 3, includes a fluid inlet Ip that is connected to the hose Tp, and an air outlet Oa that is connected to the hose Ta. The source connector Cs may thus be considered as an accessory of the source bottle S. With reference to FIGS. 4a and 4b, it can be seen that the source connector Cs comprises several component elements, namely: a base body Bs; a piston spring Rs; a piston Ps; a valve spring Rv, a valve V; and a sleeve W. The piston spring Rs, the piston Ps, the valve spring Rv, the valve V, and the sleeve W are all housed inside the base body Bs. The base body defines the fluid inlet Ip and the air outlet Oa. The sleeve W is received in stationary manner inside the base body Bs. The inside of the sleeve W is connected to the fluid inlet Ip. The sleeve W forms a slide cylinder W1 that is formed with external longitudinal grooves W2. The sleeve W also forms a collar W3 and an internal valve seat W4. At the end of the sleeve, an annular housing is formed between the collar W3 and the seat W4. The valve V is arranged inside the sleeve W together with the valve spring Rv so as to urge the valve V into leaktight contact with the seat W4 of the sleeve W. By pushing the valve V inside the sleeve W, the leaktight contact with the seat W4 is broken and a passage is established between the fluid inlet Ip and the seat W4 of the sleeve W. In addition, the air outlet Oa communicates with the annular space defined between the sleeve W and the inside of the base body Bs. The piston Ps is arranged in the annular space and, at rest, it is urged against the collar W3 of the sleeve W by the return spring Rs that extends around the sleeve W. By pushing the piston Ps out of contact with the collar W3, an air passage is established between the air outlet Oa and the collar W3, given that the piston Ps slides over the cylinder W1 of the sleeve W in non-airtight manner, as a result of the presence of the longitudinal grooves W2.

In the rest position shown in FIG. 3, the valve V closes the internal fluid passage, and the piston Ps closes the internal air passage. It can thus be said that the piston Ps acts as an airtight shutter in the rest position. As described below, it also provides an air-thrusting function while the source and travel connectors are being connected together.

The travel connector Cn, that is shown on the right in FIG. 3, includes an air inlet Ia and a fluid outlet Op. With reference to FIGS. 5a and 5b, it can be seen that the travel connector Cn comprises several component elements, namely: a base body Bn; a bushing D; a ring H; a return spring Rn; a piston Pn; and a rod J. The bushing D, the ring H, the return spring Rn, the piston Pn, and the rod J are all housed inside the base body Bn. The bushing D, the ring H, and the rod J are mounted in stationary manner inside the base body Bn, and the piston Pn is movable relative to these parts by compressing the return spring Rn. The bushing D extends inside the ring H, being fastened to the base body Bn at the fluid outlet Op. A passage is formed between the bushing D and the ring H, the passage communicating with the air inlet Ia. The inside of the bushing D communicates directly with the fluid outlet Op. The rod J is held in stationary manner inside the bushing D, being fastened on the bushing D or on the base body Bn. The inside of the bushing D forms a slide cylinder for the piston Pn. The piston thus moves around the rod J against the return spring Rn that urges it into its rest position against a head J1 formed by the rod J. At rest, the piston Pn comes into leaktight contact with the head J1. In addition, leaktight contact is also established between the piston Pn and the inside of the bushing D. The piston Pn slides in the bushing D in leaktight manner and around the rod J in non-leaktight manner. By pushing the piston Pn against the spring Rn, an internal fluid passage is established that communicates with the fluid outlet Op. It should also be observed that the piston Pn is annular and advantageously presents a rim P1 having a function that is explained below. It should also be observed that in its rest position, the piston Pn closes the air passage that communicates with the air inlet Ia. The piston Pn comes into airtight contact with the free end H1 of the ring H. The piston Pn thus performs two closure functions, one for closing the internal fluid passage and one for closing the internal air passage.

With reference to FIG. 6, the connection means C can be seen in the same state as in FIG. 3, just before connection, but the springs are removed for the purpose of clarity of the drawing. In this state, the two connectors Cs and Cn are arranged facing each other, without contact. The pistons Ps and Pn and the valve V are urged into their sealing rest positions by their respective springs Rs, Rn, and Rv. The continuous internal passages are not yet established. It should be observed that the base body Bn can come into engagement around the base body Bs. In addition, it should be observed that the free end H1 of the ring H is facing the piston Ps. It should also be observed that the rim P1 of the piston Pn is facing the annular housing W5 of the sleeve W. All of these elements participate in creating leaktight coaxial connection means, making it possible to establish continuous internal passages for the fluid and the air.

Reference is made below to FIG. 7 in which the two connectors Cs and Cn can be seen in their connected together state so as to establish continuous internal passages for the fluid and for air. In FIG. 7, the internal passages are represented by continuous arrowed lines Air and F. In this connected together state, it should be observed that the base body Bn extends, in part, around the base body Bs, making a connection, e.g. by snap-fastening, screw-fastening, bayonet fastening, etc. The free top end H1 of the ring has pushed the piston Ps inside the base body Bs, such that a passage is established at the grooves W2 of the sleeve W. In addition, the head J1 of the rod J has pushed the valve V out of contact with its seat W4. Finally, the sleeve W has pushed the piston Pn inside the bushing D, such that a passage is established between the piston Pn and the rod J. More precisely, the rim P1 of the piston Pn is engaged in the annular housing W5 of the sleeve W.

It should be observed that while the two connectors Cs and Cn are being connected together, the piston Ps is moved by the free end H1 in the direction of the air flow. In symmetrical manner, it should be observed that during connection, the piston Pn is moved in the direction of the fluid flow. Thus, each of the pistons Ps and Pn moves a quantity of air or fluid, so as to initiate the movement of the air or the fluid in its flow direction. It should be kept clearly in mind that the source bottle S and the travel bottle N are at atmospheric pressure, such that there is no pressure difference between the two bottles. As a result, it is advantageous to initiate the movement of the air and the fluid during connection, so as to overcome the effects of capillarity. It should even be observed that the pistons Ps and Pn present sections that are substantially U-shaped or V-shaped, making it possible to store a certain quantity of air or fluid therein, that is then moved while the two connectors are being connected together. The air or fluid thrust means formed by the pistons may be used in any type of connection means, whether they are coaxial as described above, or otherwise as described in document WO 2010/092310. Separate protection could even be sought for this particular characteristic.

In the embodiment shown in the drawings, the two pistons Ps and Pn are annular, and they are even arranged in coaxial manner. They are both movable between a rest position in which they close their respective internal passages, and a flow position in which the passages are open. It should also be observed that the fluid and air passages are arranged in coaxial manner over a major fraction of their length. The air passage is arranged around the fluid passage. An opposite arrangement could also be envisaged. This coaxial arrangement is present in particular at the connection interface between the two connectors. At this location, the rim P1 penetrates in leaktight manner into the housing W5, thereby forming the continuous connection of the internal fluid passage, and forming a seal relative to the outside. In addition, the free end H1 of the ring H comes into airtight bearing contact against the piston Ps so as to establish the continuous internal air passage. It can even be said that the leaktight connection of the rim P1 in the housing W5 separates the fluid passage from the surrounding air passage.

The base bodies Bs and Bn, the pistons Ps and Pn, the ring H, and the sleeve W all have cylindrical configurations, and they co-operate with one another while the two connectors Cs and Cn are being connected together, forming coaxial connection means so as to connect the internal passages in coaxial manner. These parts form two coaxial connection interfaces that reduce any risk of fluid retention or leakage during connection or disconnection as much as possible, or even eliminate it: there are no possible fluid retention profiles at the interfaces at the moment of contact between the two connectors (just before passage opening, or vice versa at the moment of passage closing). The fluid passage is closed even before the two connectors can be separated, so the fluid cannot flow to the outside. It should be observed that the sealing closures are all made at the interfaces and not inside the connectors, and this eliminates any risk of fluid retention at the interfaces.

The invention thus provides coaxial connection means that are extremely simple to use, with the user not even being aware of the cross transfer of air and fluid. Furthermore, the flow of air and fluid through the connectors is encouraged or initiated by the pistons Ps and Pn that generate starting thrust.

1. A fluid refill system comprising:
a source bottle;
a refillable travel bottle including a dispenser pump, the travel bottle presenting a capacity that is smaller than the capacity of the source bottle; and
connection means for connecting the two bottles together so as to fill the travel bottle with fluid from the source bottle, the connection means including a fluid inlet and an air outlet for the source bottle, and a fluid outlet and an air inlet for the travel bottle, the connection means defining an internal fluid passage connecting the fluid inlet to the fluid outlet, and an internal air passage connecting the air inlet to the air outlet;
the fluid refill system being characterized in that the internal fluid passage and the internal air passage are arranged coaxially, the air passage surrounding the fluid passage or vice versa.

2. A refill system according to claim 1, wherein the connection means comprise two connectors that are suitable for being connected together, namely a source connector forming the fluid inlet and the air outlet, and a travel connector forming the fluid outlet and the air inlet.

3. A refill system according to claim 2, wherein the connectors include coaxial connection means for connecting the internal passages in coaxial manner.

4. A refill system according to claim 1, wherein the connection means include thrust means
for initiating the movement of the fluid and/or of the air in a determined direction.

5. A refill system according to claim 4, wherein the thrust means comprise at least one thrust piston for thrusting the air towards the air outlet and/or the fluid towards the fluid outlet.

6. A refill system according to claim 1, wherein the thrust piston is biased by a return spring, the piston being moved against the action of the return spring while the two connectors are being connected together.

7. A refill system according to claim 5, including two thrust pistons for thrusting the air and the fluid, the pistons being arranged in coaxial manner.

8. A refill system according to claim 8, wherein both thrust pistons are annular.

9. A refill system according to claim 1, wherein each piston moves between a rest position in which the internal passage(s) is closed, and a flow position in which the internal passage(s) is open.

10. A refill system according to claim 2, wherein the source connector includes a valve for closing the internal fluid passage, the valve being pushed into its flow position against a valve spring by the travel connector while the two connectors are being connected together.

11. A refill system according to claim 2, wherein the travel connector is arranged at an end of the travel bottle, that is remote from the dispenser pump.
